(19) United States
(12) Patent Application Publication
(10) Pub. No.: US 2005/0193569 A1
(43) Pub. Date: Sep. 8, 2005

(54) Scissors

(75) Inventor: Chiu Hop, New Territories (HK)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Double C. Limited

(21) Appl. No.: 10/795,637

(22) Filed: Mar. 8, 2004

(51) Int. Cl. B26B 1/00

(52) U.S. Cl. 30/253; 30/222

(57) ABSTRACT

An improved scissors is provided. The scissors include a first scissors blade and a second scissors blade interconnected by a scissors pivot access. A concave is formed on the non-contacting surface of the first scissors blade. The scissors include a bearing sandwiched between the pivot access and the concave, and engaged with the outside of the pivot axis. A spring is disposed within grooves in each of the contacting surfaces of the scissor blades. The pivot axis is screwed to a hole of the second scissors blade. The pivot axis is adjusted to a position to make the friction force between the first and second scissor blades less than the restoring force of the spring, so that the scissor blades are not locked by a friction force.

### FIELD OF THE INVENTION

The present invention relates to improved scissors, and in particular to scissors employing a bearing.

### BACKGROUND ART

Scissors have been widely used in cutting cloth, thread or the like. Generally, scissors for cutting cloth material or the like, is composed of two blade parts, coupled by a set screw, and biased to an open position by a spring. To make the scissors operate smoothly, two blade parts are always made slightly arc-shaped, the set screw is tightly fixed to the blade parts, the friction force between the set screw and the blade parts is usually greater than the restoring force of the spring, therefore, the scissors probably do not restore to its relaxation state after cutting operation, therefore, causing the cutting operation to not operate smoothly and exhausting the user through long use.

Accordingly, it is the object of the present invention to provide an improved scissors which are easier to use to overcome the previously-mentioned shortcomings and disadvantages.

### SUMMARY OF THE INVENTION

Scissors comprise first and second scissors blade interconnected with each other by a scissors pivot joint defining a scissors pivot axis, each of said scissors blades has a hole, a contacting surface and a non-contacting surface, a respective base portion and a respective cutting portion. A biasing spring is disposed between contacting surfaces of the first and second scissors blades urging the first and second scissors blades towards an open position, through which said scissors pivot axis pierces. A groove is formed on the contact surface of the first scissors blade for engaging with a stop included in the second scissors blade. A concave is formed on the non-contacting surface of the first scissors blade, a bearing is sandwiched between the scissors pivot axis and the concave. The first scissors blade has a finger grip.

Furthermore, the scissors pivot axis is inserted into the hole of the first scissors blade by clearance and screwed to the hole of the second scissors blade. A set screw is mounted at the outer end of the hole of the second scissors blade. An aperture is located at the base portion of the second scissors blade with a spring and a ball disposed therein.

### BRIEF DESCRIPTION OF THE DRAWINGS

FIG. 1 is a front view of the present invention;

FIG. 2 is an enlarged sectional view taken along line A-A in FIG. 1;

FIG. 3 is an enlarged sectional view taken along line B-B in FIG. 1;

FIG. 4 is an enlarged sectional view taken along line C-C in FIG. 1;

FIG. 5 is a front view of the first scissors blade of the present invention;

FIG. 6 is a back view of the first scissors blade illustrated in FIG. 5;

FIG. 7 is a front view of the second scissors blade of the present invention;

FIG. 8 is a back view of the second scissors blade illustrated in FIG. 7.

### DETAILED DESCRIPTION OF PREFERRED EMBODIMENTS

The present invention will be obvious by description combined with the following drawings and the preferred embodiments.

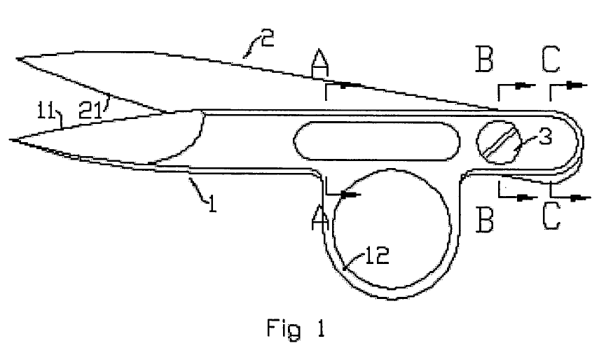

Referring to FIG. 1, a pair of scissors for cloth cutting includes the first scissors blade 1 and the second scissors blade 2 interconnected with each other by a scissors pivot axis 3, the first scissors blade 1 has a cutting portion 11 and the second scissors blade 2 has a cutting portion 21. The first scissors blade has a finger grip 12 for easily hand holding.

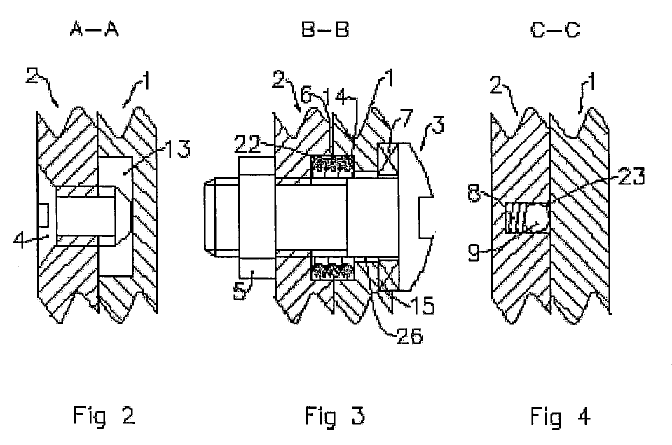

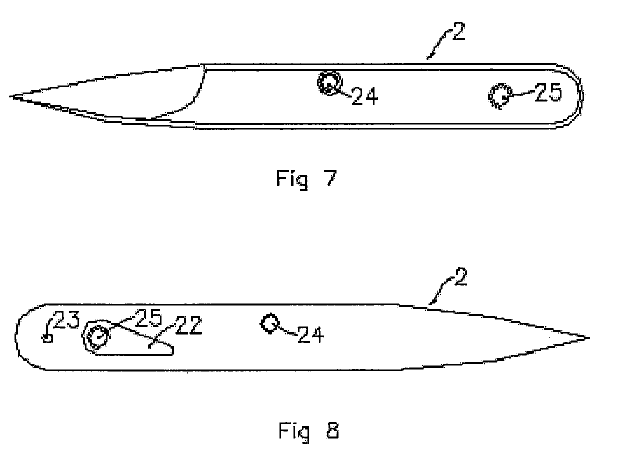

Referring to FIG. 2 and FIG. 7, a set screw 4 acts as a stop and is mounted in the hole 24 of the second scissors blade 2 and extends into the limiting groove 13 formed on the first scissors blade 1. When the first scissors blade 1 and the second scissors blade 2 are in rotating movement, the set screw 4 will be limited by the side walls of limiting groove 13, which limits positions for the scissors blade 1 and the scissors blade 2 when opening and closing the respective cutting portions.

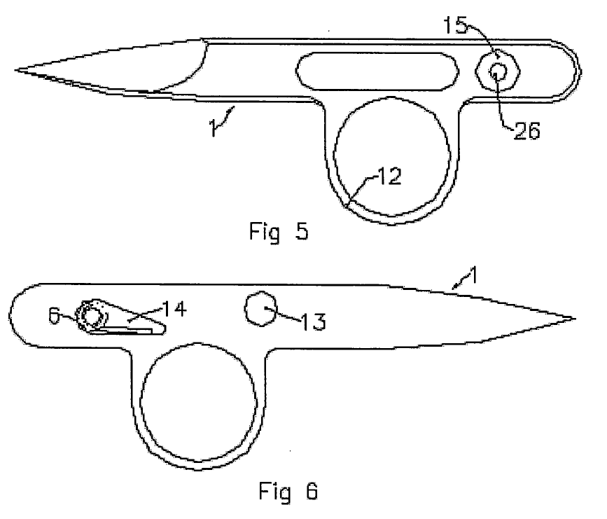

Referring to FIG. 3, FIG. 5 and FIG. 8, a concave 15 is formed on the non-contacting surface of first scissors blade 1, a bearing 7 is sandwiched between scissors pivot axis 3 and concave 15, furthermore the inside surface of the bearing 7 is engaged with the outside surface of the pivot axis 3 by clearance. Groove 14 and groove 22 are formed respectively in the contacting surfaces of the first scissors blade 1 and the second scissors blade 2, and a biasing spring 6 is disposed within groove 14 and groove 22. The pivot axis 3 is screwed into the hole 25 of the second scissors blade 2 and engaged with the hole 26 of the first scissors blade 1 by clearance, to adjust the pivot axis 3 to a proper position to make the friction force therebetween less than the restoring force of spring 6. Thus the scissors blades will not be deadly locked by the friction force, and spring 6 is able to restore to its relaxation status. To maintain the first scissors blade and the second scissors blade in a close contact, a nut 5 is mounted on the end of pivot axis 3 to improve the reliability of the movement of pivot axis 3.

Referring to FIG. 4, at the rear end of the scissors blade 2, an aperture 23 is set in the inner side of the scissors blade 2, and a compressed spring 8 and a ball 9 are set in the aperture 23, which properly decreases the friction caused by the tightly locking of the pivot axis 3, and also make the first scissors blade 1 and the second scissors blade 2 more tightly coupled.

Referring to FIG. 5, the non-contacting surface of the first scissors blade 1 is shown. The concave 15 is formed near the finger grip 12 for holding the bearing 7.

Referring to FIG. 6, the contacting surface of the first scissors blade 1 is shown. A circular limiting groove 13 is formed near the cutting portion of the scissors blade 1; it is preferable for the limiting groove 13 to have an elliptical shape. The groove 14 is formed on the base portion of the first scissors blade 1 for holding the spring 6.

Referring to FIG. 7, it shows the non-contacting surface of the second scissors blade 2 is shown. Through-hole 24 is for mating with set screw 4, and hole 25 is for mating with pivot axis 3.

Referring to FIG. 8, the contacting surface of the second scissors blade 2 is shown. An aperture 23 is formed on the base portion of the second scissors blade 2 for accommodating the compressing spring 8 and ball 9.

The foregoing description has employed a separate bearing member as the bearing. However, it will be readily apparent to those skilled in the art that the teachings of the invention apply to any kind of bearing. Examples of other bearings include: (a) cap of the pivot axis and steel balls disposed within the apertures of the first scissors blade; (b) a holding plate employed with steel balls, to name a few.

The invention has been described with reference to the preferred embodiments. Obviously, modification and alterations will occur to others upon a reading and understanding of the present application. It is intended to include such modifications and alterations.

1. Scissors, comprising:
first and second scissors blade interconnected with each other by a scissors pivot joint defining a scissors pivot axis, each of said scissors blades has a hole part, a contacting surface and non-contacting surface, a respective base portion and a respective cutting portion;
a biasing spring disposed between contacting surfaces of said first and second scissors blades urging said first and second scissors blades toward an open position, through which said scissors pivot axis pierces;
a groove formed on said contact surface of said first scissors blade for engaging with a stop included in said second scissors blade; and
a bearing sandwiched between said scissors pivot axis and said non-contacting surface of said first scissors blade.

2. The scissors according to claim 1, wherein said scissors pivot axis is engaged with said hole part of said first scissors blade by clearance and screwed to said hole part of said second scissors blade.

3. The scissors according to claim 2, wherein a nut is mounted at the outer end of said hole of said second scissors blade.

4. The scissors according to claim 1, wherein an aperture is located at said base portion of said second scissors blade, and a spring and a ball are disposed within said aperture.

5. The scissors according to claim 4, wherein said stop is a set screw.

6. The scissors according to claim 5, wherein said first scissors blade further includes a finger grip.
